(19) United States
(12) Patent Application Publication
(10) Pub. No.: US 2024/0251482 A1
(43) Pub. Date: Jul. 25, 2024

(54) ELECTRIC BLANKET

(71) Applicant: GUANGDONG LAIJUN ELECTRONIC TECHNOLOGY CO., LTD., Dongguan City (CN)

(72) Inventor: Wanglai Huang, Dongguan City (CN)

(21) Appl. No.: 18/098,696

(22) Filed: Jan. 19, 2023

(51) Int. Cl. H05B 3/34; A47G 9/06

(52) U.S. Cl. CPC H05B 3/342; A47G 9/06

(57) ABSTRACT

An electric blanket includes an electric blanket body and a power supply device for power supply and control. The power supply device includes a power plug, a main control module, and a first interface for electrical connection to the electric blanket body. The electric blanket body includes a controller, a heating load, and a second interface that is detachably connected to the first interface. The main control module is electrically connected to the heating load via the first interface and the second interface. The controller includes a button assembly for adjusting temperature.

### BACKGROUND OF THE INVENTION

### 1. Field of the Invention

The present invention relates to an electric blanket, and more particularly to an electric blanket that is simple in structure.

### 2. Description of the Prior Art

An electric blanket, also known as an electric mattress, is a contact-type electric heating appliance. A special soft, serpentine electric heating element with a standard insulation performance is disposed in the blanket to emit heat when it is energized. Warm compresses, electric heating mattresses and electric heating pads also have the same working principle as the electric blankets that can keep warm.

A conventional electric blanket generally includes an electric blanket body and a power adapter for power supply. The function buttons used to control the working state of the electric blanket body are generally disposed on the power adapter. Electric wires are connected between the power adapter and the electric blanket body. When the user wants to use the electric blanket, he/she needs to go to the position where the power adapter is located. This brings inconvenience to the use.

In these days, an electric blanket having function buttons is developed on the market, for example, the control switch and the display as disclosed in U.S. Pat. No. 10,820,376 B2. The MCU of the control switch controls the display. However, due to the existence of the MCU chip and the display, the overall circuit structure is complex, the circuit cost is high, and it is not conducive to the washing of the electric blanket. In addition, two power cables and two signal cables are required for electrical connection between the power adapter and the electric blanket body. The circuit cost is high.

Accordingly, the inventor of the present invention has devoted himself based on his many years of practical experiences to solve these problems.

### SUMMARY OF THE INVENTION

In view of the shortcomings of the prior art, the primary object of the present invention is to provide an electric blanket that that is simple in structure, without a chip and a display. The electric blanket of the present invention simplifies the circuit structure greatly, saves the production cost, and is for easy washing.

In order to achieve the above object, the present invention adopts the following technical solutions.

An electric blanket comprises an electric blanket body and a power supply device for power supply and control. The power supply device includes a power plug for electrical connection to an alternating-current electric power supply, a main control module for voltage conversion and control, and a first interface for electrical connection to the electric blanket body. The electric blanket body includes a controller, a heating load, and a second interface that is detachably connected to the first interface. The main control module is electrically connected to the heating load via the first interface and the second interface.

The controller includes a button assembly for adjusting temperature. The button assembly includes at least one button and at least two switches. The switches are triggered and controlled by the button. The second interface is electrically connected to the switches.

The main control module is electrically connected to the switches. When the button of the button assembly is operated, a corresponding one of the switches is triggered and closed, and the main control module controls a working state of the heating load after receiving a signal from the button via the second interface and the first interface in sequence.

Preferably, the button assembly further includes a plurality of resistors. The switches are connected in parallel. The switches are each connected in series with at least one of the resistors and then connected in parallel.

Preferably, the resistors of the switches have different resistance values.

Preferably, the at least one button includes a plurality of buttons corresponding in number to the number of the switches, and the buttons are arranged like keys on a musical instrument.

Preferably, the electric blanket body is a wearable electric blanket body.

Preferably, the button is a slide button, and the switches are triggered by sliding the slide button.

Compared with the prior art, the present invention has obvious advantages and beneficial effects. Specifically, the button assembly on the electric blanket body forms a mechanical button control for temperature adjustment, without a chip and a display. The electric blanket of the present invention simplifies the circuit structure greatly, saves the production cost, and is for easy washing.

Secondly, only three sockets are needed at the junction of the interfaces, which reduces the number of power cables, simplifies the overall circuit, and reduces the circuit cost.

Furthermore, the buttons are arranged like keys on a musical instrument. It is convenient for the user to intuitively understand the temperature setting of the electric blanket, so as to enhance the user experience.

In order to illustrate the structural features and effects of the present invention more clearly, the following detailed description will be given in conjunction with the accompanying drawings and specific embodiments.

### BRIEF DESCRIPTION OF THE DRAWINGS

FIG. 1 is a top view of a first embodiment of the present invention, wherein the electric blanket body is not electrically connected to the power supply device;

FIG. 2 is a block diagram of the first embodiment of the present invention; and

FIG. 3 is a top view of a second embodiment of the present invention, wherein the electric blanket body is not electrically connected to the power supply device.

### DETAILED DESCRIPTION OF THE PREFERRED EMBODIMENTS

Embodiments of the present invention will now be described, by way of example only, with reference to the accompanying drawings.

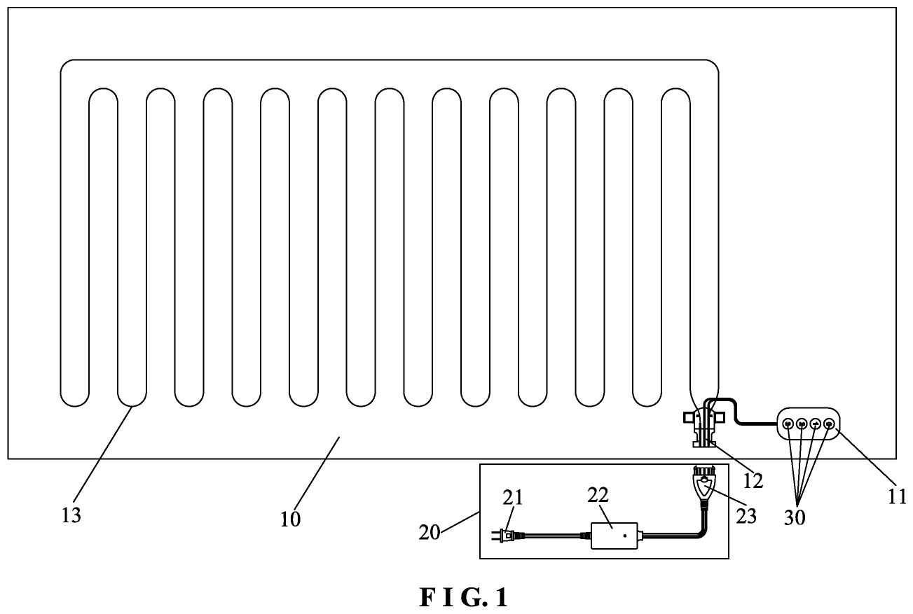

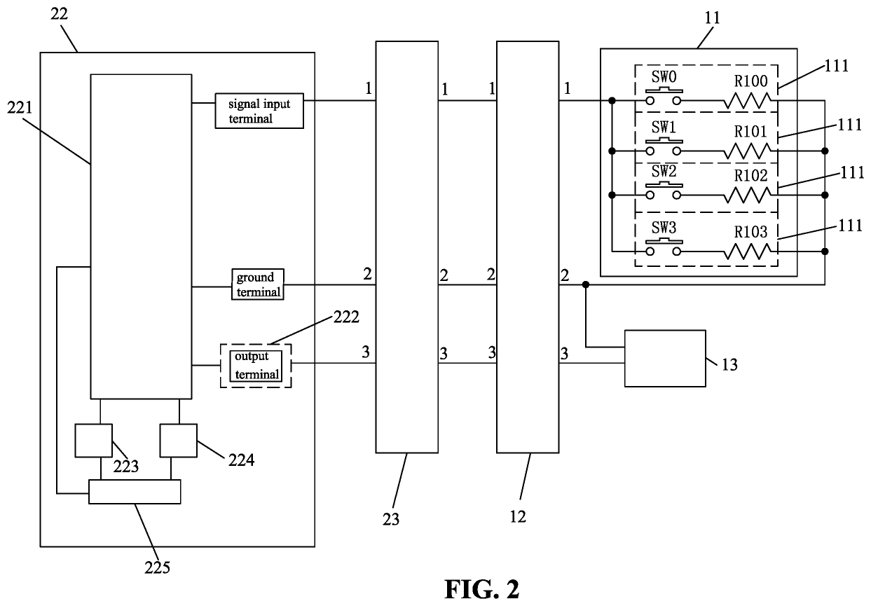

As shown in FIG. 1 and FIG. 2, the present invention discloses an electric blanket that is simple in structure. The electric blanket comprises an electric blanket body 10 and a power supply device for power supply and control. In a first embodiment, the electric blanket body 10 is a wearable electric blanket body.

The power supply device includes a power plug 21 for electrical connection to an alternating-current electric power supply, a main control module 22 for voltage conversion and control, and a first interface 23 for electrical connection to the electric blanket body 10.

The electric blanket body 10 includes a controller 11, a heating load 13, and a second interface 12 that is detachably connected to the first interface 23. The main control module 22 is electrically connected to the heating load 13 via the first interface 23 and the second interface 12 for controlling the working state of the heating load 13.

The controller 11 includes a button assembly 111 for adjusting temperature. The button assembly 111 includes at least one button 30, a plurality of resistors, and at least two switches. The switches are triggered and controlled by the button 30. The second interface 12 is electrically connected to the switches.

The main control module 22 is electrically connected to the switches. When the button 30 of the button assembly 111 is operated, the switch is triggered and closed, and the main control module 22 controls the working state of the heating load 13 after receiving the signal from the button via the second interface 12 and the first interface 23 in sequence.

All the switches are connected in parallel. The switches are each connected in series with at least one resistor and then connected in parallel. Preferably, the resistors of the switches have different resistance values. For example, each switch may be connected in series with a different number of resistors having the same resistance value. For example, one switch is connected in series with a 10-ohm resistor, and the other switch is connected in series with two 10-ohm resistors, as long as the total resistance value in each parallel circuit is different.

In the first embodiment, the number of the buttons corresponds to the number of the switches. All the buttons 30 are arranged like keys on a musical instrument. When one of the buttons 30 of the button assembly 111 is pressed, the corresponding switch is triggered and closed by the button 30, and the main control module 22 controls the working state of the heating load 13 after receiving the signal from the button via the second interface 12 and the first interface 23 in sequence.

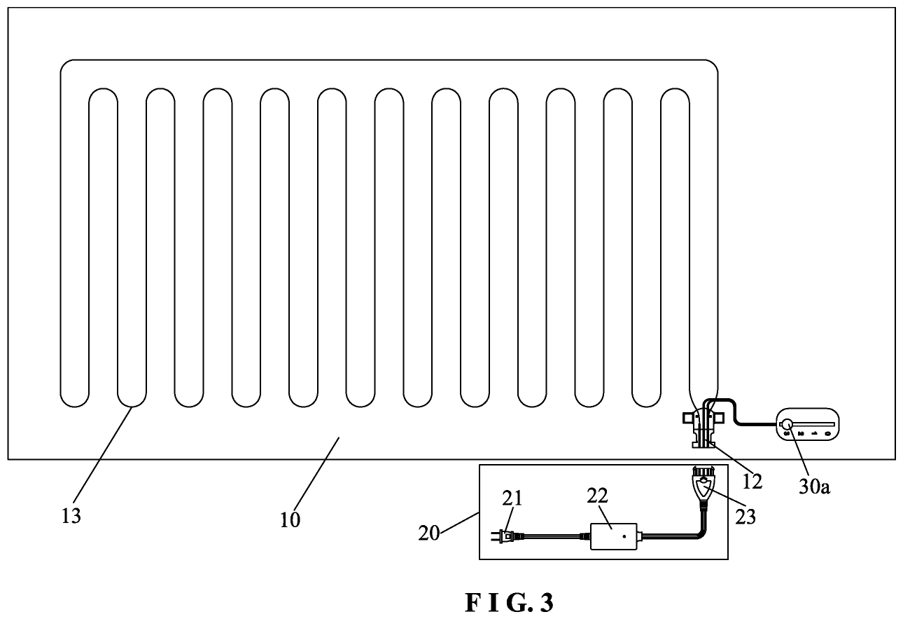

FIG. 3 illustrates a second embodiment of the present invention. The second embodiment is substantially similar to the first embodiment with the exceptions described below. The button is a slide button 30a. The switches are triggered by sliding the slide button 30a. When the slide button 30a slides to a corresponding one of the switches, the corresponding switch is triggered and closed, and the main control module 22 controls the working state of the heating load 13 after receiving the signal from the button via the second interface 12 and the first interface 23 in sequence.

In the first embodiment, the main control module 22 includes a main control circuit 221, an output control circuit 222, and a voltage conversion circuit 225 for converting the AC electric power supply and supplying power. The main control circuit 221 is electrically connected to the output control circuit 222. The main control circuit 221 has a signal input terminal and a ground terminal. The main control circuit 221 is electrically connected with a current detection circuit 223 and a voltage detection circuit 224. The output control circuit 222 has an output terminal. The main control circuit 221 is connected to the heating load 13 via the output terminal of the output control circuit 222.

The pin 1 of the first interface 23 is electrically connected to the signal input terminal. The pin 2 of the first interface 23 is electrically connected to the ground terminal. The pin 3 of the first interface 23 is electrically connected to the output terminal. The pin 1 and the pin 2 of the second interface 12 are electrically connected to two ends of the button assembly 111, respectively. The pin 2 and the pin 3 of the second interface 12 are connected to two ends of the heating load 13, respectively.

The first interface 23 is electrically connected to the second interface 12. The pin 1 of the first interface 23 is electrically connected to the pin 1 of the second interface 12. The pin 2 of the first interface 23 is electrically connected to the pin 2 of the second interface 12. The pin 3 of the first interface 23 is electrically connected to the pin 3 of the second interface 12.

Next, four temperature levels (each temperature level corresponds to one button 30) are taken as an example to explain the principle.

The four temperature levels of the buttons 30 increase progressively and are defined as a level 0, a level 1, a level 2 and a level 3, respectively. As shown in the figures, the button assembly 111 includes four buttons 30 and four switches defined as a switch SW0, a switch SW1, a switch SW2 and a switch SW3, respectively. The switch SW0, the switch SW1, the switch SW2 and the switch SW3 are each active when pressed and reset when pressed again; alternatively, after another button is pressed, the previous pressed button is reset automatically, but not limited thereto.

The button assembly 111 includes four resistors having different resistance values. The four resistors are defined as a resistor R100, a resistor R101, a resistor R102 and a resistor R103. The resistor R100, the resistor R101, the resistor R102 and the resistor R103 and the nodes not connected in series of the corresponding switches, are grounded, respectively. The switch SW0, the switch SW1, the switch SW2 and the switch SW3 and the nodes not connected in series of the corresponding resistors are electrically connected to the pin 2 of the second interface 12, respectively.

After the temperature level 1 is pressed, the signal from the button, corresponding to the switch SW1, is input to the main control circuit 221 of the main control module 22 via the pin 2 of the second interface 12 and the pin 2 of the first interface 23 in sequence. The main control circuit 221 of the main control module 22 controls the working state of the heating load 13 through the output control circuit 222.

The feature of the present invention is that the button assembly on the electric blanket body forms a mechanical button control for temperature adjustment, without a chip and a display. The electric blanket of the present invention simplifies the circuit structure greatly, saves the production cost, and is for easy washing.

Secondly, only three sockets are needed at the junction of the interfaces, which reduces the number of power cables, simplifies the overall circuit, and reduces the circuit cost.

Furthermore, the buttons are arranged like keys on a musical instrument. It is convenient for the user to intuitively understand the temperature setting of the electric blanket, so as to enhance the user experience.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. An electric blanket, comprising an electric blanket body and a power supply device for power supply and control; the power supply device including a power plug for electrical connection to an alternating-current electric power supply, a main control module for voltage conversion and control, and a first interface for electrical connection to the electric blanket body; the electric blanket body including a controller, a heating load, and a second interface that is detachably connected to the first interface, the main control module being electrically connected to the heating load via the first interface and the second interface;
the controller including a button assembly for adjusting temperature, the button assembly including at least one button and at least two switches, the switches being triggered and controlled by the button, the second interface being electrically connected to the switches;
the main control module being electrically connected to the switches, wherein when the button of the button assembly is operated, a corresponding one of the switches is triggered and closed, and the main control module controls a working state of the heating load after receiving a signal from the button via the second interface and the first interface in sequence.

2. The electric blanket as claimed in claim 1, wherein the button assembly further includes a plurality of resistors, the switches are connected in parallel, and the switches are each connected in series with at least one of the resistors and then connected in parallel.

3. The electric blanket as claimed in claim 2, wherein the resistors of the switches have different resistance values.

4. The electric blanket as claimed in claim 1, wherein the at least one button includes a plurality of buttons corresponding in number to the number of the switches, and the buttons are arranged like keys on a musical instrument.

5. The electric blanket as claimed in claim 1, wherein the electric blanket body is a wearable electric blanket body.

6. The electric blanket as claimed in claim 1, wherein the button is a slide button, and the switches are triggered by sliding the slide button.
